(19) United States
(12) Patent Application Publication
(10) Pub. No.: US 2015/0116855 A1
(43) Pub. Date: Apr. 30, 2015

(54) MANUAL MIRROR

(71) Applicant: DAITO PRESS MANUFACTURING CO., LTD., Osaka (JP)

(72) Inventor: Takashi YOSHIDA, Osaka (JP)

(73) Assignee: DAITO PRESS MANUFACTURING CO., LTD., Osaka (JP)

(21) Appl. No.: 14/516,495

(22) Filed: Oct. 16, 2014

(30) Foreign Application Priority Data
Oct. 30, 2013 (JP) 2013-225712

(51) Int. Cl. G02B 7/182

(52) U.S. Cl. CPC G02B 7/1821
USPC 359/873

(57) ABSTRACT

A manual mirror, capable of obtaining optimum clamp force on a mirror support stay while reducing the number of components and simplifying the structure of the mirror, includes a mirror body and mounting section for attaching the mirror body to the mirror support stay. The mounting section is constructed mainly of a pair of brackets projecting from and integrally formed with a side of mirror housing and a U-shaped clamp member and a fastener, and the mirror housing being integrally formed with, on another side, projection fitting between a pair of arms of the U-shaped clamp member for restricting a displacement of arms which come close to each other while allowing a displacement which reduces clamp width of a holding part of the U-shaped clamp member when the fastener is tightened.

### BACKGROUND OF THE INVENTION

1. Field of the Invention

The present invention relates to a manual mirror which permits position adjustment of the mirror by hand.

2. Background Art

A mirror body of a conventional manual mirror includes, on one side, a mirror plate and is attached through a mounting section to a mirror support stay so as to be rotatable around an axis of the mirror support stay and to be tiltable relative to the mirror support stay (refer to, for example, Japanese Patent Unexamined Publication No. 2011-074641).

FIG. 5 illustrates the structure of the mounting section of the conventional manual mirror.

Main components of the conventional manual mirror are made of steel.

In this manual mirror, mounting section 102 for fixing mirror body 100 to mirror support stay 101 is constructed mainly of plate-shaped pedestal 103, U-shaped bracket 104, U-shaped clamp member 105 and fastener 106.

Here, U-shaped clamp member 105 is formed of holding part 105a for holding mirror support stay 101, and a pair of arms 105b, 105b extending linearly from holding part 105a.

In mounting section 102 of the manual mirror, U-shaped bracket 104 is fixed firmly to plate-shaped pedestal 103 by spot welding or the like, and plate-shaped pedestal 103 is fixed to the other side of mirror body 100 by being fastened by screws 108 to reinforcing plate 107 mounted inside mirror body 100. U-shaped bracket 104 and the pair of arms 105b, 105b of U-shaped clamp member 105 are fastened by fastener 106 in a mutually rotatable manner.

In above-described mounting section 102, tightening fastener 106 causes a displacement such that arms 105b, 105b of U-shaped clamp member 105 come close to each other. However, if the displacement is too small, clamp force of U-shaped clamp member 105 exerted on mirror support stay 101 is too small to fix position of mirror body 100 that moves unexpectedly due to vibration etc. so that it is in unsuitable condition for use. If the displacement is too large, clamp force of U-shaped clamp member 105 on mirror support stay 101 is too large, so that adjusting the mirror position by hand becomes difficult.

To obtain optimum clamp force which prevents the unexpected movement of mirror body 100 due to the vibration or the like but allows the adjustment of the position of mirror body 100 by hand, a pair of arms 105b, 105b of U-shaped clamp member 105 has a U-shaped section all over an area extending from a base end to a leading end of arm 105b with respective open sides of the U-shaped sections facing each other, thus allowing resultant flanges 109, 109 to come into abutting relationship with each other. When the displacement of arms 105b, 105b which come close to each other as a result of the tightening of fastener 106 reaches a predetermined amount corresponding to the optimum clamp force, flanges 109, 109 abut against each other, thereby restricting the displacement.

However, the conventional manual mirror requires plate-shaped pedestal 103, reinforcing plate 107 and others for fixing U-shaped bracket 104 to mirror body 100, which increases the number of components. Moreover, the conventional manual mirror requires the pair of arms 105b, 105b to be provided with respective flanges 109, 109 for restricting the displacement of arms 105b, 105b of U-shaped clamp member 105 that come close to each other when fastener 106 is tightened. For this reason, the shape of U-shaped clamp member 105 is complicated, problematically causing difficulty in simplifying the structure of the manual mirror.

The present invention is directed toward solving the problems discussed above and aims to provide a manual mirror capable of obtaining optimum clamp force on a mirror support stay while reducing the number of components and simplifying the structure of the mirror.

### SUMMARY OF THE INVENTION

To achieve the above object, a manual mirror according to a first aspect of the present invention comprises a mirror body having a mirror plate on a side of the mirror body, and a mounting section through which the mirror body is attached to a mirror support stay such that the mirror body is rotatable around an axis of the mirror support stay and tiltable relative to the mirror support stay,

wherein the mounting section includes:

a pair of brackets projecting from and integrally formed with an other side of the mirror body, the brackets disposed at a prescribed interval;

a U-shaped clamp member including a holding part for holding the mirror support stay, and a pair of arms extending linearly from the holding part; and

a fastener passing through the pair of arms for fastening the arms and the pair of brackets in a mutually rotatable manner,

wherein a projection is integrally formed on the other side of the mirror body to be fitted between the pair of arms for restricting a displacement of the arms which come close to each other while allowing a displacement which reduces a clamp width of the holding part when the fastener is tightened.

Next, a manual mirror according to a second aspect of the present invention comprises a mirror body having a mirror plate on a side of the mirror body, and a mounting section through which the mirror body is attached to a mirror support stay such that the mirror body is rotatable around an axis of the mirror support stay and tiltable relative to the mirror support stay,

wherein the mounting section includes:

a pair of brackets projecting from and integrally formed with an other side of the mirror body, the brackets disposed at a prescribed interval;

a U-shaped clamp member including a holding part for holding the mirror support stay, and a pair of arms extending linearly from the holding part; and

a fastener passing through the pair of arms for fastening the arms and the pair of brackets in a mutually rotatable manner,

wherein a projection is formed on at least one of the pair of arms at a portion defined between a part of the arm where the fastener passes through and a leading end of the arm, the projection jutting out inwardly for restricting a displacement of the arms which come close to each other while allowing a displacement which reduces a clamp width of the holding part when the fastener is tightened.

According to a third aspect of the invention that is based on the first or second aspect, it is preferable that a step is provided exterior to the pair of brackets on the other side of the mirror body.

In the manual mirror of the first aspect of the invention, the mounting section for attaching the mirror body to the mirror support stay is constructed mainly of the pair of projecting brackets integrally formed with the other side of the mirror body, the U-shaped clamp member and the fastener. Thus, components required in a conventional manual mirror such as a plate-shaped pedestal and a reinforcing plate are eliminated, allowing reduction in the number of components.

The projection integrally provided to the other side of the mirror body to fit between the pair of arms of the U-shaped clamp member restricts the displacement of the arms which come close to each other when the fastener is tightened, so that a flange formed all over an area of each of a pair of arms that extends from a base end of the arm to a leading end of the arm as required for a U-shaped clamp member of the conventional manual mirror is eliminated. Thus, the U-shaped clamp member can be simplified in shape, allowing simplification of the structure of the manual mirror.

When the fastener is tightened, the displacement which reduces the clamp width of the holding part of the U-shaped clamp member is allowed, thus clamp force exerted by the U-shaped clamp member on the mirror support stay can be adjusted according to the amount of tightening of the fastener. Consequently, optimum clamp force which prevents an unexpected movement of the mirror body due to vibration etc. but allows adjustment of the position of the mirror with respect to the mirror support stay by hand can be obtained with ease.

Similarly to the manual mirror of the first aspect of the invention, the manual mirror of the second aspect of the invention eliminates components such as the plate-shaped pedestal and the reinforcing plate that are required in the conventional manual mirror, thus allowing reduction in the number of components.

In the U-shaped clamp member, the projection, provided at the site defined between the part of at least one of the pair of arms where the fastener passes through and the leading end of the arm, and which juts out inwardly, restricts the displacement of the arms which come close to each other when the fastener is tightened, so that similarly to the manual mirror of the first aspect, the mirror of the second aspect can be simplified in structure.

Moreover, when the fastener is tightened, the displacement which reduces the clamp width of the holding part of the U-shaped clamp member is allowed. Consequently, similarly to the manual mirror of the first aspect, the mirror of the second aspect can obtain optimum clamp force with ease.

According to the third aspect of the invention, the step is provided on the other side of the mirror body exterior to the pair of brackets, so that even when a displacement which reduces the space between the pair of brackets occurs as a result of the tightening of the fastener, the step can suppress deformation of the mirror body that is affected by such a displacement.

### BRIEF DESCRIPTION OF THE DRAWINGS

FIG. 1 is a side view of a manual mirror in accordance with an exemplary embodiment of the invention.

FIG. 2 is an illustration viewed from the direction of arrow A in FIG. 1.

FIG. 3 is a sectional view taken along line B-B in FIG. 2.

FIG. 4 illustrates variations of a mounting section.

FIG. 5 illustrates the structure of a mounting section of a conventional manual mirror.

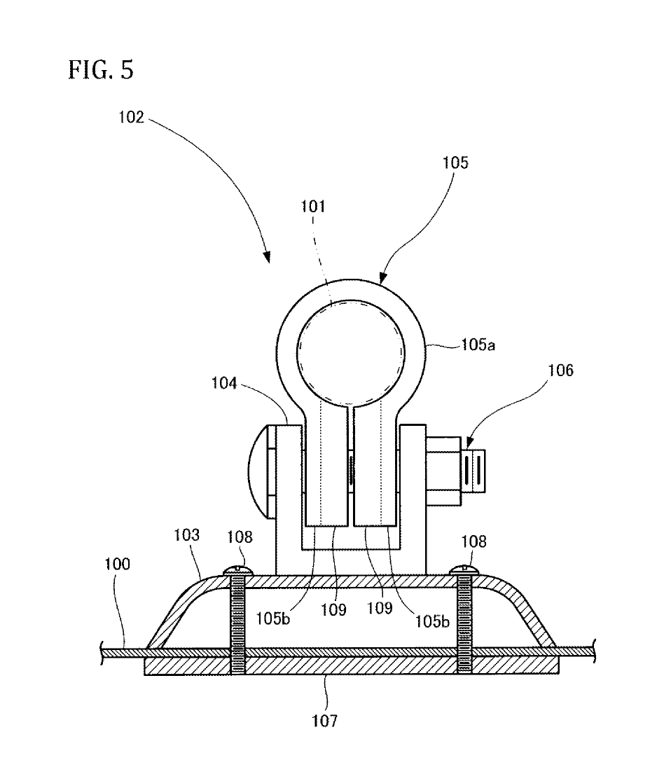

### DETAILED DESCRIPTION OF THE INVENTION

A concrete exemplary embodiment of a manual mirror according to the present invention is demonstrated hereinafter with reference to the accompanying drawings.

### Brief Description of the Manual Mirror

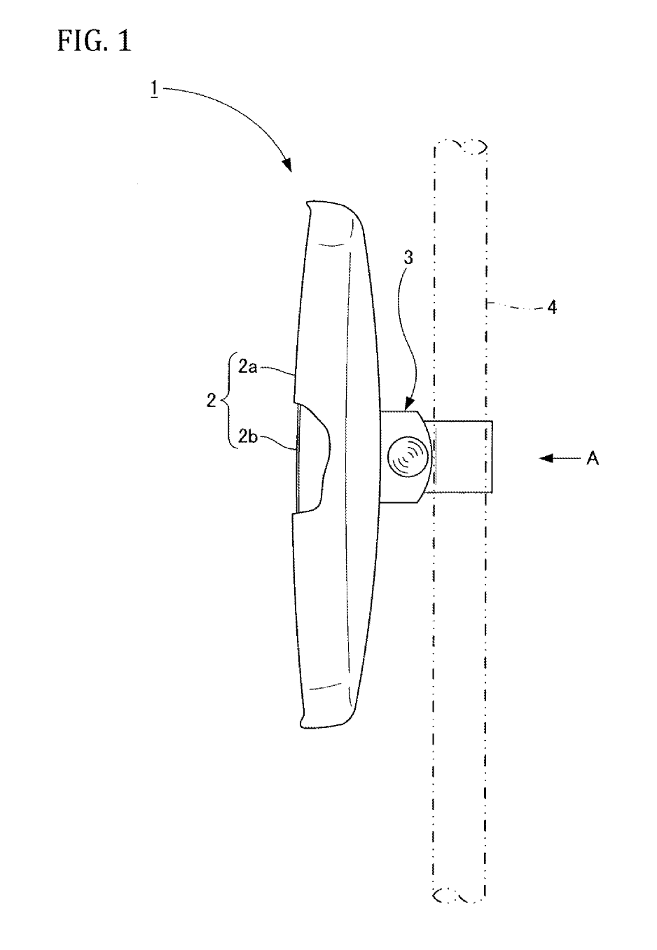

Manual mirror 1 shown in FIG. 1 includes mirror body 2 including mirror housing 2a made of resin material such as polypropylene, and mirror plate 2b fitted to one side of mirror housing 2a.

In this manual mirror 1, mirror body 2 is attached to mirror support stay 4 provided to, for example, a vehicle side of a construction machine (not shown in the drawing) through mounting section 3. Mirror body 2 is rotatable around an axis of mirror support stay 4 and tiltable relative to mirror support stay 4, thus allowing adjustment of the position of the mirror by hand.

(Description of the Mounting Section)

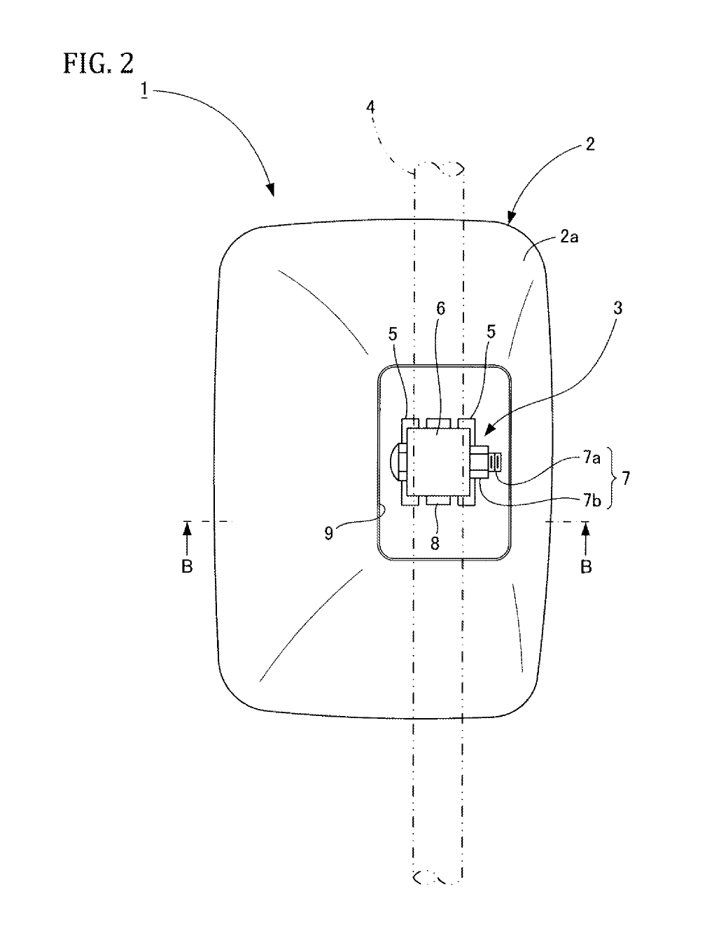

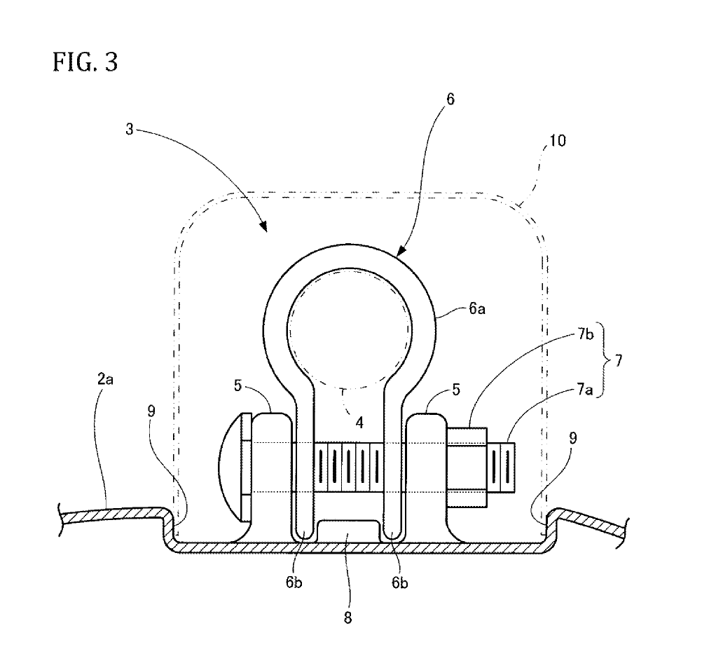

As shown in FIGS. 2 and 3, mounting section 3 is constructed mainly of a pair of brackets 5, 5, U-shaped clamp member 6 and fastener 7.

The pair of brackets 5, 5 are disposed at a prescribed interval in a projecting manner on the other side of mirror body 2, that is, the other side of mirror housing 2a and are integrally formed with mirror housing 2a by resin molding.

U-shaped clamp member 6 is formed of resin material such as polypropylene, POM (polyacetal), nylon 6 or nylon 66 by resin molding to be used in an inverted position as shown in FIG. 3. This clamp member 6 includes holding part 6a having a round shape for holding mirror support stay 4, and a pair of arms 6b, 6b extending linearly from holding part 6a.

Fastener 7 is formed of bolt 7a which passes through the pair of arms 6b, 6b of U-shaped clamp member 6 as well as the pair of brackets 5, 5, and nut 7b into which bolt 7a is screwed. The function of fastener 7 is to fasten brackets 5, 5 and arms 6b, 6b in a mutually rotatable manner.

(Description of a Projection)

On the other side of mirror housing 2a, projection 8 is integrally formed with mirror housing 2a by resin molding so as to fit between the pair of arms 6b, 6b of U-shaped clamp member 6. When fastener 7 is tightened, projection 8 restricts such a displacement that respective leading ends of arms 6b, 6b come close to each other, while allowing a displacement which reduces clamp width of holding part 6a of U-shaped clamp member 6.

(Description of a Step)

On the other side of mirror housing 2a, step 9 is provided exterior to the pair of brackets 5, 5. Therefore, even when a displacement which reduces the space between the pair of brackets 5, 5 occurs as a result of the tightening of fastener 7, this step 9 can suppress deformation of mirror housing 2a that is affected by such a displacement.

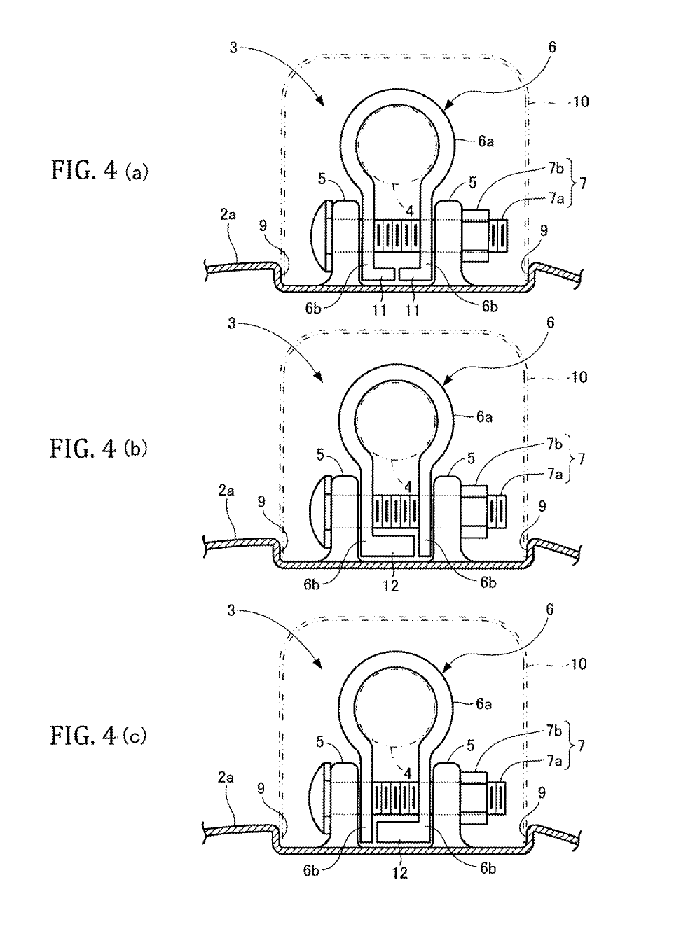

It is to be noted here that step 9 is mounted with cover member 10 (shown only in FIGS. 3 and 4 for convenience of explanation) for covering mounting section 3, whereby dust and others can be prevented from entering mounting section 3, and mirror 1 can maintain its beauty in appearance.

(Description of Effects)

In manual mirror 1 constructed as described above, the pair of brackets 5, 5 are integrally formed with the other side of mirror housing 2a by resin molding to project therefrom, so that plate-shaped pedestal 103, reinforcing plate 107 and others that are required in the conventional manual mirror can be eliminated, thus allowing reduction in the number of components.

Projection 8 is integrally provided to the other side of mirror housing 2a to fit between the pair of arms 6b, 6b of U-shaped clamp member 6. This projection 8 restricts the displacement of the respective leading ends of arms 6b, 6b that come close to each other when fastener 7 is tightened, so that flanges 109, 109, each of which is formed all over an area extending from a base end of each of the pair of arms 105b, 105b of U-shaped clamp member 105 to a leading end of arm 105b and is required in the conventional manual mirror, can be eliminated. The shape of U-shaped clamp member 6 can thus be simplified, allowing simplification of the structure of manual mirror 1 and manufacture of U-shaped clamp member 6 with ease by resin molding.

When fastener 7 is tightened, the displacement which reduces the clamp width of holding part 6a of U-shaped clamp member 6 is allowed, so that clamp force exerted by U-shaped clamp member 6 on mirror support stay 4 can be adjusted according to the amount of tightening of fastener 7. Consequently, optimum clamp force which prevents an unexpected movement of mirror body 2 due to vibration etc. but allows adjustment of the position of mirror body 2 by hand can be obtained with ease with respect to mirror support stay 4.

The embodiment of the manual mirror according to the present invention has been described above. However, the present invention is not limited to the structure described in the above embodiment and allows appropriate variations on the structure without departing from the spirit of the invention.

For example, although in the above-described embodiment, projection 8 is integrally provided to the other side of mirror housing 2a to fit between the pair of arms 6b, 6b of U-shaped clamp member 6 in order to restrict the displacement of the respective leading ends of arms 6b, 6b that come close to each other as fastener 7 is tightened, the invention is not limited to this, and as shown in FIG. 4(a), each of the pair of arms 6b, 6b of U-shaped clamp member 6 may be provided with, at a site defined between a part of arm 6b where fastener 7 (bolt 7a) passes through and a leading end of arm 6b, projection 11 jutting out inwardly. Alternatively, one of arms 6b, 6b may be provided with projection 12 jutting out inwardly at the site defined between the part of arm 6b where fastener 7 (bolt 7a) passes through and the leading end of arm 6b as shown in FIGS. 4(b) and 4(c). Projections 11, 12 both restrict the displacement of the respective leading ends of arms 6b, 6b that come close to each other when fastener 7 is tightened.

The manual mirror according to the present invention has the characteristics of allowing the reduction in the number of components and the simplification of its structure as well as the characteristic of being capable of obtaining the optimum clamp force on the mirror support stay and therefore, is suitable for use as a rearview mirror of a work vehicle such as the construction machine or a dump truck.

1. A manual mirror comprising a mirror body having a mirror plate on a side of the mirror body, and a mounting section through which the mirror body is attached to a mirror support stay such that the mirror body is rotatable around an axis of the mirror support stay and tiltable relative to the mirror support stay,
wherein the mounting section includes:
a pair of brackets projecting from and integrally formed with an other side of the mirror body, the brackets disposed at a prescribed interval;
a U-shaped clamp member including a holding part for holding the mirror support stay, and a pair of arms extending linearly from the holding part; and
a fastener passing through the pair of arms for fastening the arms and the pair of brackets in a mutually rotatable manner,
wherein a projection is integrally formed on the other side of the mirror body to be fitted between the pair of arms for restricting a displacement of the arms which come close to each other while allowing a displacement which reduces a clamp width of the holding part when the fastener is tightened.

2. A manual mirror comprising a mirror body having a mirror plate on a side of the mirror body, and a mounting section through which the mirror body is attached to a mirror support stay such that the mirror body is rotatable around an axis of the mirror support stay and tiltable relative to the mirror support stay,
wherein the mounting section includes:
a pair of brackets projecting from and integrally formed with an other side of the mirror body, the brackets disposed at a prescribed interval;
a U-shaped clamp member including a holding part for holding the mirror support stay, and a pair of arms extending linearly from the holding part; and
a fastener passing through the pair of arms for fastening the arms and the pair of brackets in a mutually rotatable manner,
wherein a projection is formed on at least one of the pair of arms at a portion defined between a part of the arm where the fastener passes through and a leading end of the arm, the projection jutting out inwardly for restricting a displacement of the arms which come close to each other while allowing a displacement which reduces a clamp width of the holding part when the fastener is tightened.

3. The manual mirror of claim 1, wherein a step is provided exterior to the pair of brackets on the other side of the mirror body.

4. The manual mirror of claim 2, wherein a step is provided exterior to the pair of brackets on the other side of the mirror body.
